(19) United States
(12) Patent Application Publication
(10) Pub. No.: US 2007/0066319 A1
(43) Pub. Date: Mar. 22, 2007

(54) Network configuration method allotting channels to wireless stations by generating a broadcast tree

(75) Inventor: Youiti Kado, Kyoto (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/516,530

(22) Filed: Sep. 7, 2006

(30) Foreign Application Priority Data
Sep. 8, 2005 (JP) 2005-261208

(51) Int. Cl. H04Q 7/20

(52) U.S. Cl. 455/450

(57) ABSTRACT

All wireless stations included in a wireless multi-hop network are allocated to one of channels available to the network as a common channel. A broadcast tree beginning from any one of the wireless stations is generated based on link information including path information on all links formed between two wireless stations communicatable in one hop. Branch information of the generated broadcast tree is used to group all of the wireless stations into blocks, and to each block is allocated a subchannel different from the common channel. A wireless station that can use the channels has its subchannel to a subchannel of group to which it belongs. Adjacent wireless stations in a wireless multi-hop network may thus be effectively allocated to communication channels, and may need minimum modification of the channels.

### BACKGROUND OF THE INVENTION

1. Field of the Invention

The present invention relates to a wireless communication system and a network configuration method, which are particularly applicable to, for example, a wireless multi-hop network that is constructed according to an autonomous distributed control. Specifically, the present invention relates to a method of controlling a network configuration that connects, with a plurality of channels, wireless stations to each other, each of the wireless stations including one or more radio-frequency (RF) modules, or transmitter and receiver modules.

2 Description of the Background Art

Japanese application patent laid-open publication No. 290229/1998 discloses a conventional feature that uses multiple channels to thereby increase the amount of communication conveyable. This publication proposes scanning of channels to detect a carrier and select the optimum channel, or the like.

Further, there has already been provided a wireless access point or the like that combines an RF module of IEEE (Institute of Electric and Electronics Engineers) 802.11a with an RF module of IEEE 802.11b/g, so that the communication amount is increased.

The conventional technology, however, is not adapted to comply with the environment of wireless multi-hop networks. For example, although IEEE 802.11a regulates four channels available, one RF module uses only one channel, and wireless stations each including two RF modules use two channels to communicate with each other. In the wireless multi-hop network, such wireless stations are connected in the form of multiple stages, and the necessity of parallel communications with neighbor wireless stations is extensive, so that it is often insufficient to provide each wireless station with two channels available.

It would therefore be appreciated to allocate, in an application having two RF modules provided, channels shifted to each of the RF modules so as to use four channels in total. The connection condition of the wireless stations depends, however, on the changes of the wireless environment, and movement and condition of the wireless stations, so that it may be necessary to change the channels to be allocated to the RF modules. Changing the channels allocated to one RF module corresponds for other wireless stations to the changes of the wireless environment, causing further changes of the allocated channels. Changing the allocated channels in a broader service area may cause more overhead.

### SUMMARY OF THE INVENTION

It is an object of the present invention to provide a wireless communication system and a network configuration control method that may effectively allocate channels to adjacent wireless stations and may need minimum modification of the channels.

The present invention provides a method of allocating channels in a wireless multi-hop network including a plurality of wireless stations, comprising the steps of: allocating one of a plurality of channels available to the wireless multi-hop network as a common channel common to all of the plurality of the wireless stations; generating a broadcast tree beginning from any one of the plurality of wireless stations based on link information including path information on all of links formed between two of the plurality of wireless stations communicable in one hop; using information on a branch of the generated broadcast tree to group all of the plurality of wireless stations into blocks; and allocating to each of the blocks as a subchannel one of the plurality of channels which is different from the common channel to thereby decide the subchannels for the plurality of wireless stations corresponding to the plurality of channels.

The present invention also provides a wireless communication system comprising a wireless station as a component of a wireless multi-hop network, the wireless station being allocated to a common channel and a subchannel according to the method allocating the channels described above.

In accordance with the present invention, in addition to the common channel being allocated to the wireless stations, a different subchannel is allocated to each of the blocks or groups of the wireless station. The adjacent wireless stations may thus be effectively allocated to the channels, including subchannels. The allocation of the common channel and subchannels may need minimum modification of the communication channels.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the basic configuration of a wireless station including one transmitter and receiver module according to an embodiment of the present invention;

FIG. 2 is a schematic block diagram showing the basic configuration of a wireless station including two transmitter and receiver modules according to the illustrative embodiment of the present invention;

FIG. 3 schematically illustrates an arrangement of the wireless stations and a link configuration according to the illustrative embodiment;

FIG. 4 is a flowchart of the basic flow of a channel allocation according to the illustrative embodiment;

FIG. 5 illustrates an example of generation of a broadcast tree according to the illustrative embodiment;

FIG. 6 is a flowchart of subchannel allocation for a hop requiring the relay by two or less wireless stations according to the illustrative embodiment;

FIG. 7 is a flowchart of subchannel allocation for a hop requiring the relay by three wireless stations according to the illustrative embodiment;

FIG. 8 is a flowchart of subchannel allocation for a hope requiring the relay by four or more wireless stations according to the illustrative embodiment;

FIG. 9 schematically illustrates the channels available on the links after the subchannels are allotted for the link information on the arrangement shown in FIG. 3 is ended;

FIG. 10 schematically illustrates two wireless networks before coupled according to an alternative embodiment of the present invention;

FIG. 11 schematically illustrates two wireless networks after coupled according to the alternative embodiment;

FIG. 12 schematically illustrates two wireless networks before coupled according to the alternative embodiment;

FIG. 13 schematically illustrates two wireless networks after coupled according to the alternative embodiment;

FIG. 14 schematically illustrates a channel modification in one of the wireless networks associated with the coupling according to the alternative embodiment; and

FIG. 15 schematically illustrates, similarly to FIG. 9, the modification to the illustrative embodiment shown in FIGS. 1 and 2.

### DETAILED DESCRIPTION OF THE PREFERRED EMBODIMENTS

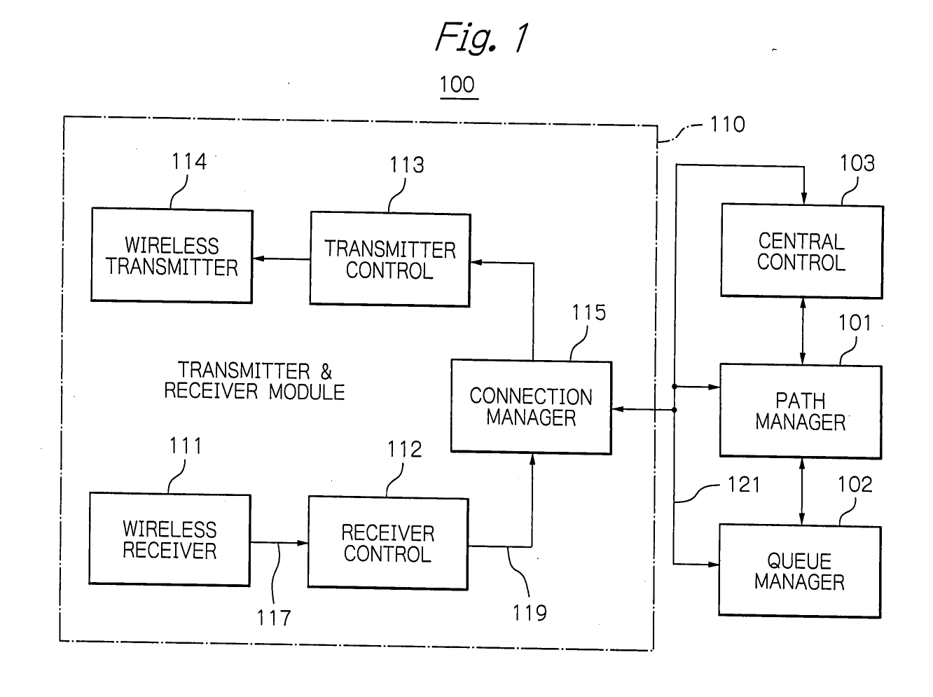

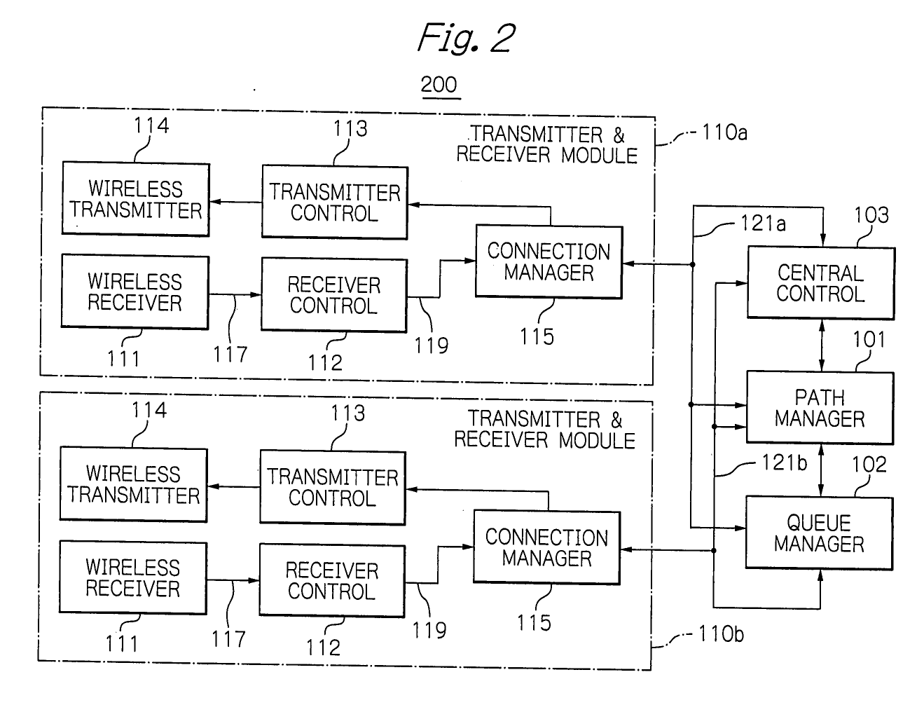

With reference to the accompanying drawings, a description will be given below on the wireless communication system of an illustrative embodiment according to the present invention. FIGS. 1 and 2 are schematic block diagrams showing the basic configuration of a wireless station according to an embodiment of the present invention. More specifically, FIG. 1 depicts the basic configuration of a wireless station 100 including a single transmitter and receiver module 110. FIG. 2 shows the basic configuration of a wireless station 200 including a couple of transmitter and receiver modules 110a and 110b. In the application, like components are designated with the same reference numerals with repetitive description thereon being refrained from for avoiding redundancy.

As shown in FIG. 1, the wireless station 100 includes a path manager 101, a queue manager 102, a central control 103 and the single transmitter and receiver module 110, which are interconnected as illustrated. In FIG. 2, the wireless station 200 is shown, which includes the path manager 101, the queue manager 102, the central control 103 and the couple of transmitter and receiver modules 110a and 110b, which are interconnected as illustrated. The transmitter and receiver modules 110, 110a and 110b has the same configuration. Each of them includes a wireless receiver 111, a receiver control 112, a transmitter control 113, a wireless transmitter 114 and a connection manager 115, which are also interconnected as illustrated in the figures.

The wireless transmitter 114 is adapted to transmit wireless signals. The wireless receiver 111 is adapted to receive wireless signals. It is to be noted that any suitable wireless or radio wave communication method may be applied.

The receiver control 112 serves as extracting packets 119 from a received wireless signal 117 to inform the central control 103 via the connection manager 115 of the reception of the packets 119. In the description, signals are designated with reference numerals applied to connections on which they are conveyed. The receiver control 112 also serves as being responsive to instructions from the central control 103 to provide the received packet 119 via the connection manager 115 to the central control 103 and/or queue manager 102. The system may be configured to provide relay packets received via the connection manager 115 to the transmitter control 113.

The transmitter control 113 is adapted to generate or update management information such as a destination and the number of hops to be included in packets, and convert packets into a corresponding wireless signal. Packets to be transmitted are provided from the central control 103 or queue manager 102.

The connection manager 115 performs, with the instant illustrative embodiment, a wireless media access control such as CSMA/CA (Carrier Sense Multiple Access with Collision Avoidance). The connection manager 115 manages signal inputs 119 from the receiver control 112 and a transmission instruction provided on the connection 121, 121a or 121b from the central control 103, and switch the transmitting and receiving operations.

The path manager 101 functions as managing information from the wireless station 100, such as information on a single-hop link, e.g. the address of a wireless station to be linked, the transfer rate, and the latest communication time, multi-hop path information, e.g. the address of a destination wireless station to be connected, the address of the wireless station in the next hop, the number of hops and the number of remaining hops, information on other links on the network, as well as load information on other wireless stations. The path manager 101 also holds information necessary for selecting paths. Information on a destination wireless station and on a wireless channel allocated to a wireless station 100 adjacent thereto is also held by the path manager 101.

The queue manager 102 is adapted to hold packets required to be relayed and packets generated in the wireless station 100 in which the queue manager 102 is installed, and be responsive to instructions from the central control 103 to pass the packets in sequence to the transmitter and receiver module 110.

The central control 103 control the above-described components of the wireless station 100 or 200. The central control 103 works together with an information processing unit or the like associated with the wireless station 100 or 200.

The two transmitter and receiver modules 110a and 110b disposed in the relevant wireless station 200 operate, when the wireless station 200 normally operates in a wireless multi-hop network, with the common channel and the subchannel of the wireless multi-hop network allocated thereto. The transmitter and receiver modules 110a and 110b in the wireless station 200 operate, when the wireless station 200 works as a gateway wireless station, with the respective common channel of the two wireless multi-hop networks allocated thereto. The latter function will be described below with respect to an alternative embodiment.

For the former function, i.e. acting as a normal wireless station, the path manager 201 holds path information including condition information on wireless channel allocation in one network. For the latter function, i.e. acting as a gateway wireless station, the path manager 201 holds, as separate path information, path information including condition information on wireless channel allocation in the two networks.

Difference in channel may be of, for example, a carrier frequency. The channels may be distinguished from other points of view. For example, the channels may be identified according to the difference in modulation method of wireless signals. In the latter case, differences may exist in processing by the modulator in the wireless transmitter 114, or in processing by the demodulator in the wireless receiver 111.

The normal wireless station 200 may not necessarily include two modules for transmitting and receiving the common channel and subchannel. Any variable type of single high-speed transmitter and receiver module may be used that may rapidly switch the channels and communicate on the common channel and subchannel in a time-sharing manner without any problems.

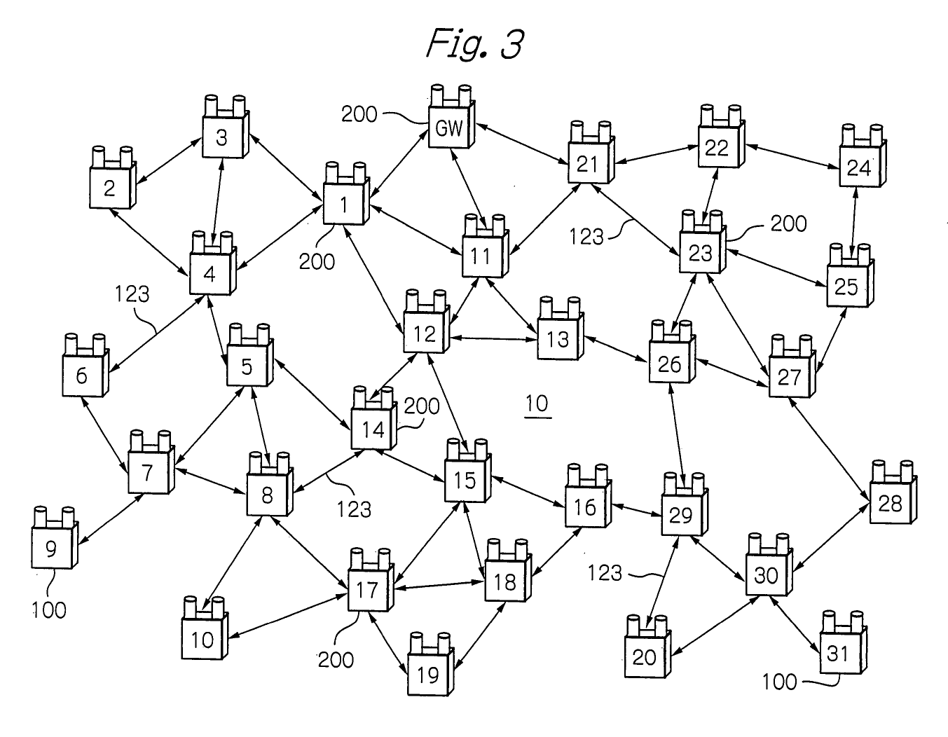

Well, FIG. 3 shows an example of the wireless communication system 10 according to the illustrative embodiment, which may include the wireless stations 100 shown in FIG. 1 and/or the wireless stations 200 shown in FIG. 2. The wireless communication system 10 according to the illustrative embodiment shown in FIG. 3 includes the wireless stations numbered as #1 through #31 and designated with GW, each of which is connectable via the wireless links expressed by arrows 123. The wireless stations #1 to #31 and GW may preferably be the wireless station 200 that includes the two transmitter and receiver modules 110a and 110b. The wireless stations 100 may be applied to some of the wireless stations, such as the wireless station numbered as #9 and #31, for example.

In FIG. 3, the wireless station designated with GW functions as a gateway wireless station. The gateway wireless station GW has the function of connecting the wireless multi-hop network 10 with an external network. The external network may be a wired network or wireless network. In the case of wired network, the gateway station includes a wired transmitter and receiver module in addition to the configuration 100 or 200 shown in FIG. 1 or 2. The gateway wireless station GW holds link information on the wireless multi-hop network 10. The gateway wireless station GW may transfer packets received from the external network and addressed to a wireless station 100 or 200 existing in the wireless multi-hop network 10.

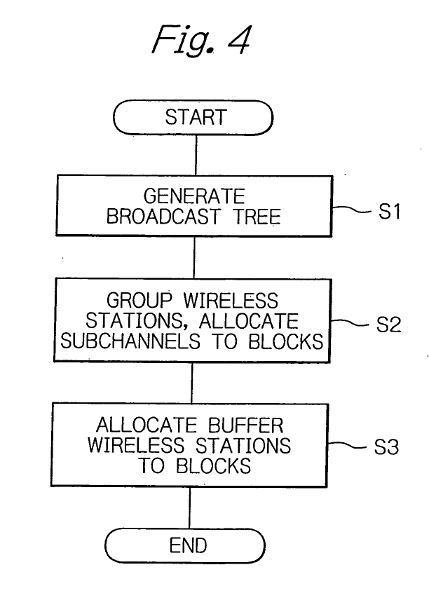

A description will now be given on the subchannel allocation, which is a characteristic operation of the wireless communication system 10 according to the illustrative embodiment. The subchannel allocation may generally be divided into the following three main operations as shown in FIG. 4: operation S1 selecting a wireless station requiring relay; operation S2 grouping the wireless stations into blocks and allocating subchannels to the blocks; and operation S3 allocating or reviewing buffer wireless stations to the blocks. The operations will be described below in sequence.

The subchannel allocation may be performed by, for example, the central control 103 in the gateway wireless station 200, the central control 103 in any predetermined wireless station 100 or 200, an external device other than the wireless stations 100 and 200, or a plurality of devices acting in a distributed processing manner. A subchannel of each wireless station may be incorporated in the form of information on a destination wireless station or on a wireless channel allocated to the adjacent wireless station or the like into the above-described single-hop link information, multi-hop path information, information on other links on the network 10 or the like, and be then transferred to the wireless stations to be held by the path manager 101 thereof.

With the illustrative embodiment, for example, during the start-up of the wireless communication system 10, the device for performing the subchannel allocation as stated above may autonomously start the subchannel allocation.

In the operation S1, a wireless station 100 or 200 requiring relay will be selected. The gateway wireless station GW uses information on wireless multi-hop network links developed as shown in FIG. 3 which is held in the gateway station GW as a basis to generate a broadcast tree for the wireless stations in the wireless multi-hop network 10. The broadcast tree defines the effective paths for packets when the gateway wireless station GW provides the same information to all the wireless stations in the wireless multi-hop network 10. The broadcast tree may be generated under the condition where, for example, there are the fewest hops from the gateway station GW to each wireless station with redundant broadcast relays excluded. The condition “with the redundant broadcast relay excluded” is directed to a case where, for example, each link between adjacent wireless stations should be used only once in either direction, or a case where, when there are plural paths to a node which have the same number of hops, the source node for that node should be one of the immediately preceding nodes which allows the most nodes to receive during its one communication operation.

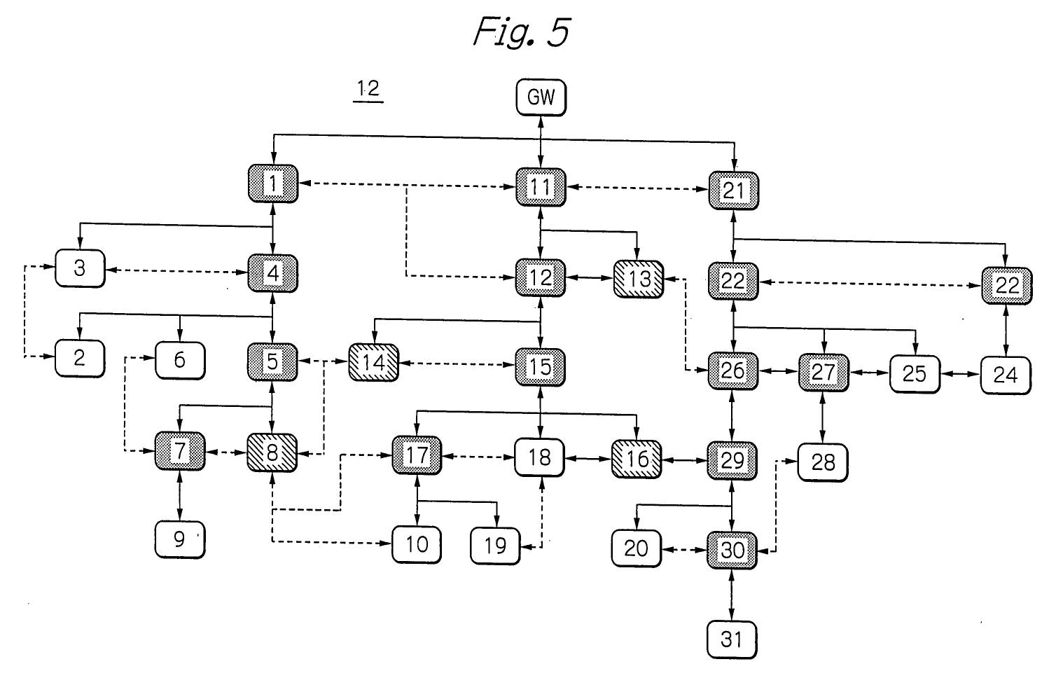

Now, reference will be made to FIG. 5, which shows an example of the broadcast tree 12 generated by applying the above-described generation condition and based on the information on the links shown in FIG. 3. In the figure, the broadcast tree 12 is defined by the links depicted with solid arrows, and the links depicted with broken arrows are the links which have the information on the links shown in FIG. 3 and do not form the broadcast tree 12.

The example of information on the links shown in FIG. 3 includes the wireless stations #1, #11 and #21 to which data may be transferred from the gateway wireless station GW in one hop. The broadcast tree 12 thus defines the stations #1, #11 and #21 immediately below the gateway GW. In the broadcast tree 12, the number of the nodes, equal to the number of the links, immediately below the gateway GW corresponds to the number of the stems of the broadcast tree 12. The example shown in FIG. 5 has three stems.

The example of information on the links shown in FIG. 3 also includes the wireless stations #1, #3, #4, #11, #12, #13, #21, #22 and #23 to which data may be transferred from the gateway wireless station GW in two hops. Excluding from the above set of the wireless stations the wireless stations to which data may be transferred from the gateway wireless station GW in one hop leaves the wireless stations #3, #4, #12, #13, #22 and #23. Those wireless stations remaining are dangled from the wireless station nodes of their relaying sources, respectively. The wireless station #12, when dangling from either of the wireless stations #1 and #11, would provide two hops. Applying a rule that the number of daughter nodes should be equalized between the wireless stations #1 and #11 permits the wireless station #12 to be a daughter node of the wireless station #11.

The same processing may subsequently be repeated to form the broadcast tree 12. For example, the wireless station #8, when dangling from either of the wireless stations #5 and #14, would not change in number of hops. The dangling from the wireless station #5 may provide two daughter nodes of the wireless station #5. In contrast, the dangling from the wireless station #14 would provide one daughter node of the wireless station #14 so that the number of the daughter nodes differs by one. In this case, application of a rule that when the number of the daughter nodes differs by one the wireless station should dangle from one of the wireless stations which provides more daughter nodes permits the wireless station #8 to be the daughter node of the wireless station #5. Such rules may be applied to decrease the number of wireless stations to be involved in relaying as will be described below.

The wireless stations in the broadcast tree 12 may be classified into two types: one serving as relaying packets or signals, sometimes simply referred to as “wireless station to be involved in relaying” and depicted with meshed boxes in FIG. 5; and the other not serving as relaying packets or signals. The latter wireless stations, other than the wireless stations to be involved in relaying, may be classified into a specific wireless station and a buffer wireless station, which are depicted with a white and a hatched box, respectively, in FIG. 5. The specific wireless station is specific to a stem to which that station belongs and may not move to different stems. The buffer wireless station may move to different stems. Although the buffer wireless station may also be defined additionally as having the same number of hops at a destination stem to which the station would move, the example shown in FIG. 5 defines the buffer wireless stations as having more hops at a destination stem.

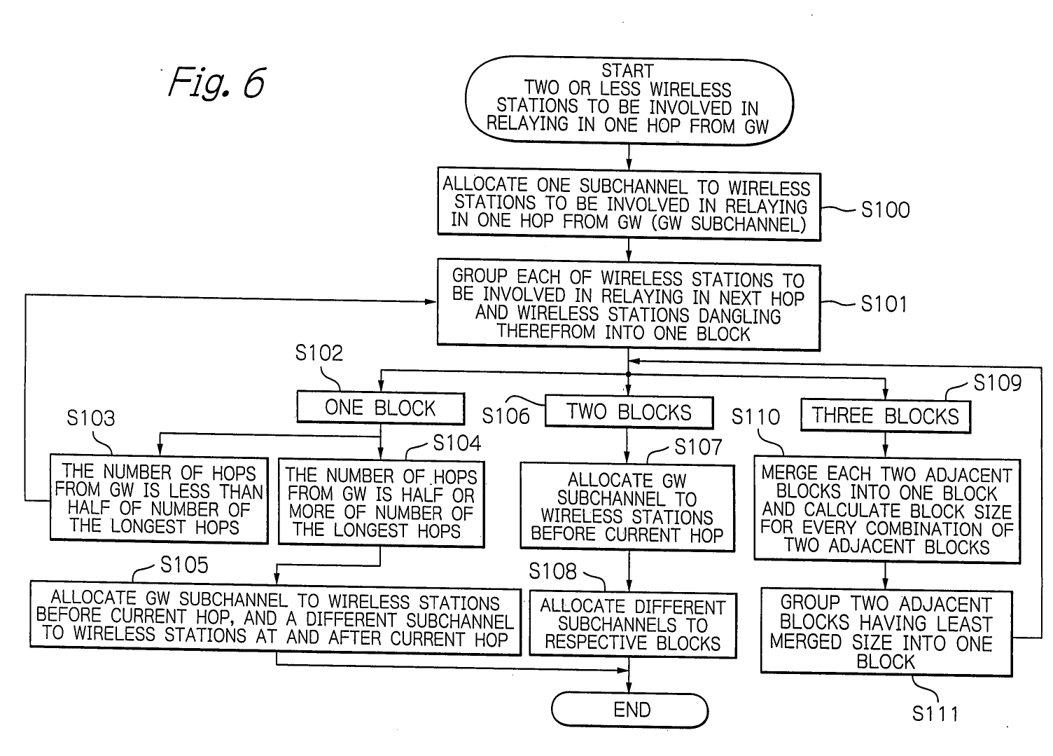

In operation S2, the wireless stations will be grouped into blocks, and a subchannel will be allotted to each block. Referring further to FIGS. 6, 7 and 8, a description will be given below on the grouping of the wireless stations and the channel allocation. Specifically, first, description will be made on a case of allocating, in addition to a common channel, one of three channels to all or some of the wireless stations as a subchannel. The wireless stations are grouped into blocks which correspond in number to the subchannels to be allocated (here, three). Each block is allocated to a different subchannel.

The common channel may be provided when the link information on the wireless network 10 (see FIG. 3) is set in the gateway device GW. Alternatively, a random number generation function or the like built in the gateway device GW may be used to select one of the four channels as the common channel and the remaining three channels as the subchannel. For the former, a common channel may be set which is different from a wireless network adjacent thereto.

FIGS. 6, 7 and 8 are flowcharts of the block division and channel allocation for the cases of two or less, three and four or more, respectively, broadcast tree stems, which correspond in number to the wireless stations to be involved in relaying in one hop from the gateway wireless station GW.

In the case of two or less wireless stations to be involved in relaying in one hop from the gateway wireless station GW, the same subchannel, referred to as GW subchannel, is first allocated as shown in FIG. 6 to all wireless stations to be involved in relaying in one hop from the gateway wireless station GW (step S100).

Moving to the next hop, each wireless station to be involved in relaying at the current hop and the wireless stations dangling therefrom are grouped into one block (S101), and the blocks are counted. FIG. 5 corresponds to the case of three, not two or less, gateway wireless stations to be involved in relaying in one hop from the gateway wireless station GW. Step S101 applied to the broadcast tree in FIG. 5 will provide four wireless stations #4, #12, #22 and #23 to be involved in relaying in two hops from the gateway GW, thus providing four blocks.

After the step S101, if there is one block (S102), it is then determined whether or not the number of hops resultant from step S101 is less than half of the number of the longest hops. If it is less than half of the number of the longest hops (S103), the process returns to the step S101. If it is half or more of the number of the longest hops (S104), the GW subchannel is allocated to the wireless stations corresponding before the number of hops resultant form step S101, and a different subchannel is allocated at step S105 to the wireless stations corresponding equal to or exceeding the number of hops resultant from step S101. The processes in FIG. 6 are then ended.

In short, if there is one block, the process moves to the next hop and performs again the grouping. When the number of hops from the gateway wireless station GW is equal to or exceeds half of the number of the longest hops, the wireless stations before the current hop are grouped into one block and the wireless stations at the current and following hops are grouped into another block. The GW subchannel is allocated to the former, and a different subchannel is allocated to the latter.

FIG. 5 corresponds to the three, not two or less, gateway wireless stations to be involved in relaying in one hop from the gateway wireless station GW. If the number of the longest hops in the case of FIG. 5 were calculated, the it would be six, which starts from the gateway GW and ends at the wireless station #31.

If there are two blocks (S106) resultant from the step S101, then the GW subchannel is allocated to the wireless stations corresponding before the number of hops resultant from step S101 (S107), and different other subchannels are allocated to respective blocks (S108). The processes in FIG. 6 are then ended.

If there are three or more blocks resultant from the step S101 (S109), the size of a block obtained by merging or incorporating two adjacent blocks with each other is calculated for every combination of two adjacent blocks (S110). The combination of two adjacent blocks having the least size obtained by merging is grouped into one block (S111). The process then returns to the block number count processes (S102, S106 and S109). The adjacent blocks mean two different blocks, if any, that include respective wireless stations connected to each other by the solid-line link or broken-line link shown in FIG. 5. The block size is expressed, for example, by the total of the number of wireless stations to be involved in relaying included in a block plus the number of wireless stations (specific wireless stations) that have the former wireless stations relay and no directly link to wireless stations to be involved in relaying in another block. The specific wireless station thus refers to a wireless station that is not directly linked to a wireless station to be involved in relaying in another block. Conversely, the buffer wireless station refers to a wireless station that is also directly linked to a wireless station to be involved in relaying in another block.

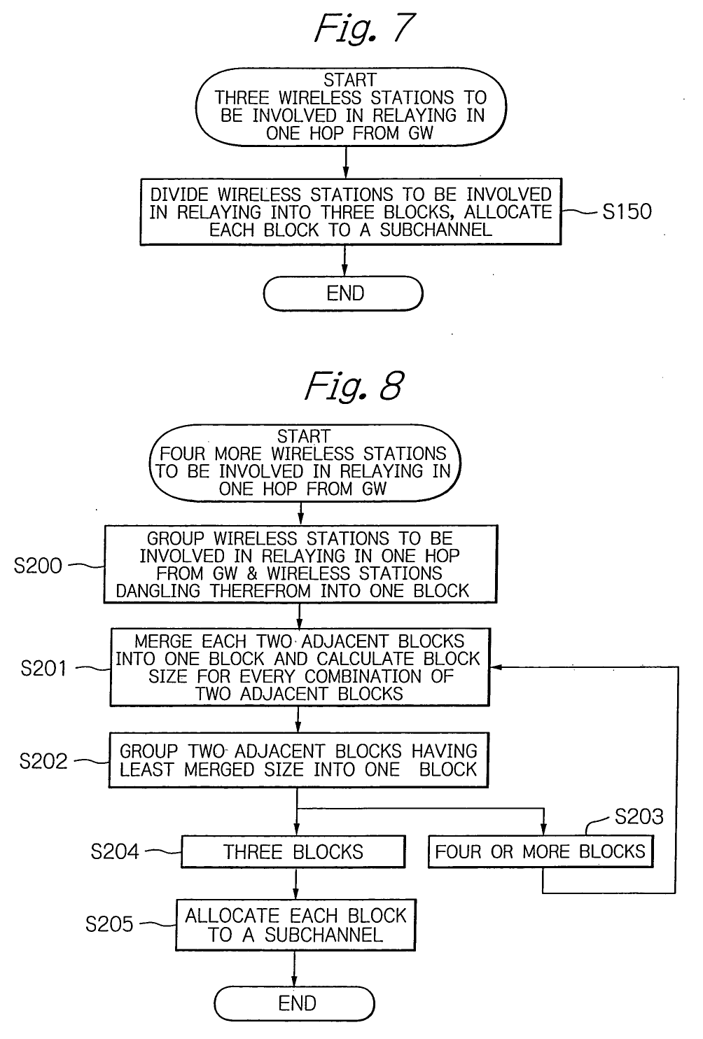

If the formed broadcast tree has three wireless stations to be involved in relaying in one hop from the gateway wireless station GW, then the wireless stations to be involved in relaying are divided into three blocks with respect to the stems thereof, each of the blocks then being allocated to a different subchannel at step S150, FIG. 7. The processes in FIG. 7 are then ended.

If the formed broadcast tree has four or more wireless stations to be involved in relaying in one hop from the gateway wireless station GW, each wireless station to be involved in relaying and the wireless stations dangling therefrom are then grouped into one block at step S200, FIG. 8. At this point, there are formed the same number of blocks as the wireless stations to be involved in relaying in one hop from the gateway wireless station GW. The size of a block which would be resultant from merging two adjacent blocks is calculated for every combination of two adjacent blocks (S201). The combination of two adjacent blocks having the smallest size resultant from the merging is grouped into one block (S202). The number of the blocks resultant from the merging is then counted. If there are still four or more blocks after merging (S203), the process returns to the step S201. If there are three blocks after merging (S204), each block is then allocated to a different subchannel (S205). The processes in FIG. 8 are then ended.

In the operation S3, a buffer wireless station will be allocated to each block or reviewed. The buffer wireless station allocation to each block will be reviewed from the following points of view. A buffer wireless station that directly links to the wireless stations to be involved in relaying in two or more blocks is allocated to one of those blocks in such a way that the block sizes are averaged. For example, candidates of grouping are provided each of which has different buffer wireless stations belong, and one of the candidates that has its block size most averaged is selected so as to adjust the grouping of the buffer wireless stations in accordance with the selected grouping. The modification of the grouping, i.e. blocks to which the buffer wireless stations belong, corresponds to the modification of the subchannels that are allocated to the buffer wireless stations.

The subchannel thus determined, which is different from the common channel, is used in the manner as will be described below. If the wireless multi-hop network 10 includes the wireless station 100 that has the single transmitter and receiver module 100, that station 100 communicates with other wireless stations over the common channel.

In the network 10, two wireless stations 200 each including the two transmitter and receiver modules 110a and 110b operate to communicate with each other in the manner which will be described below. When the same subchannel is allocated to the two wireless stations 200 connected via a link, the two channels, i.e. the common channel and the subchannel are available so that, depending on the availability of each channel, one of the channels is selected for each packet, resultantly selecting in one of the transmitter and receiver modules 110a and 110b for transferring a packet. When different subchannels are allocated to the two wireless stations 200 connected via a link, one of the transmitter and receiver modules 110a and 110b which has the common channel set is used for transferring packets.

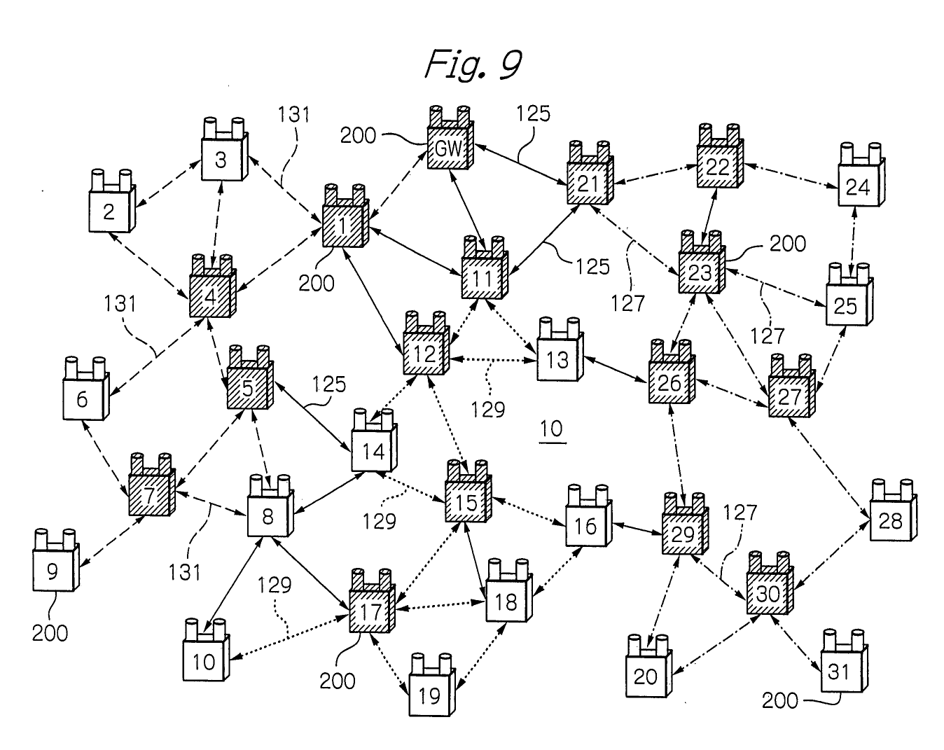

FIG. 9 shows the channels available on each link after the above described subchannel allocation is completed for the information on the links shown in FIG. 3. It is supposed that all the wireless stations, including the gateway wireless station GW, in the network system 10 are the type 200 having the couple of transmitter and receiver modules 110a and 110b.

In FIG. 9, the links depicted with solid arrow 125 may be applied only with the common channel. The links depicted with dot-and-dash arrows 127 may be applied with the common channel and first subchannel. The links depicted with dotted arrows 129 may be applied with the common channel and second subchannel, and the links depicted with broken arrows 131 may be applied with the common channel and third subchannel.

When the wireless multi-hop network 10 includes the gateway wireless station GW, there are many communication services, such as VoIP (Voice over Internet Protocol) and video streaming, that take as a dominant performance the communication amount between the gateway wireless station and other wireless stations.

The channel allocation, particularly the subchannel allocation, of the illustrative embodiment performs a radial grouping when the wireless stations 100 and 200 are arranged two-dimensionally from the gateway wireless station GW, i.e. three or more wireless stations to be involved in relaying in one hop from the gateway wireless station GW. Alternatively, the channel allocation performs the grouping by delimiting each section when the wireless stations are arranged one-dimensionally, i.e. two or less wireless stations to be involved in relaying in one hop from the gateway wireless station GW. Thereafter, subchannels are allocated to each block in both the grouping methods. The illustrative embodiment may thus autonomously and effectively allocate the channels to the adjacent wireless stations. Because of the buffer wireless stations defined, a subchannel maybe selected for each buffer wireless station to equalize loads between the subchannels, which may also provide the effective channel allocation.

When developing a communication service that depends largely upon the traffic between the gateway wireless station and each wireless station in the network 10, the effective channel allocation stated above may make two channels available in as many links as possible, and allow a plurality of available channels to be used effectively.

The effective channel allocation may also reduce as many situations as possible where the channels need to be modified. Further, because of the buffer wireless stations defined, even when the impending situation of a wireless resource such as subchannels requires the channels to be modified, only the subchannel of the buffer wireless station needs to be modified without reallocating the channels from the beginning.

One of the subchannels allocated to the wireless stations in the first hop in the broadcast tree 12 maybe selected, as necessary, as a subchannel of the gateway wireless station GW, thereby reducing the use of the common channel of the gateway wireless station GW and avoiding the impending situation of the wireless resource, e.g. the common channel.

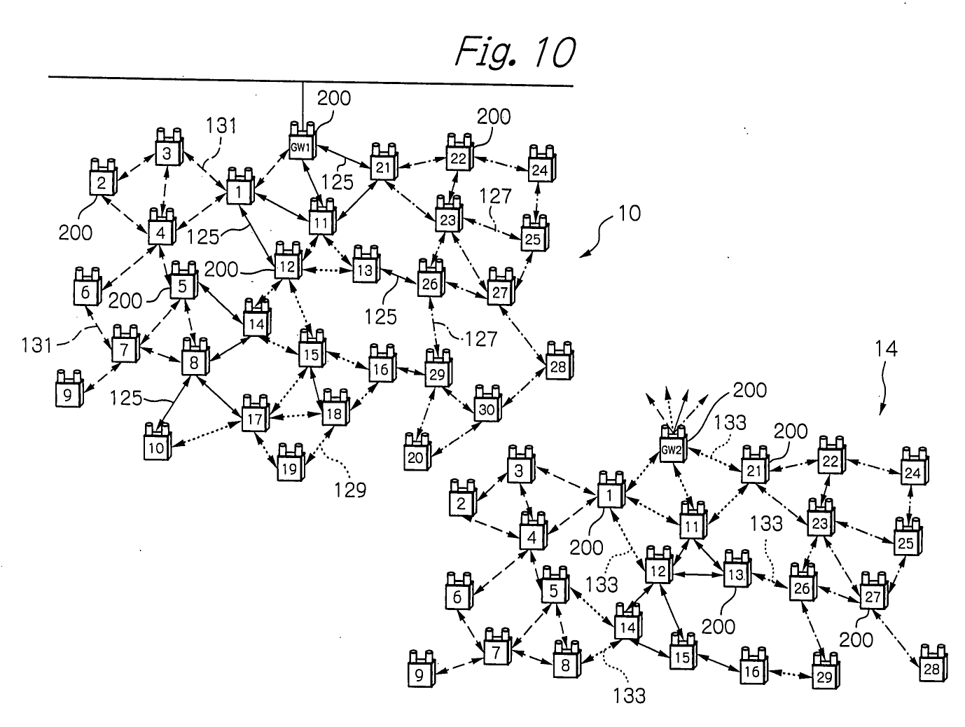

Further with reference to the accompanying drawings, a description will be given below on the wireless communication system of an alternative embodiment according to the present invention. The alternative embodiment is specifically characterized by the gateway wireless station GW1, FIG. 10, for example, which works for the cooperation between the wireless multi-hop network 10 to which the gateway wireless station GW1 belongs and another network 14, FIG. 10, thus the gateway wireless station GW1 being able to autonomously be connected with the other network 14 usually after having allocated channels as the illustrative embodiment shown and described above, but not limited thereto, of course. Such a connection operation may correspond to positive searching operation conducted by the gateway wireless station GW1 per se or to a connection triggered by recognizing a signal transmitted from the other network 14.

In the alternative embodiment, the wireless station 200, FIG. 2, is also applicable to the gateway wireless station GW1. The gateway wireless station GW1 works for the cooperation between the wireless multi-hop network 10 to which the gateway wireless station GW1 belongs and the other network 14. The gateway wireless station GW1 may thus use, for example, the one transmitter and receiver module 110a for communication with other elements or wireless stations in the wireless multi-hop network 10 to which that gateway wireless station GW1 belongs. The gateway wireless station GW1 may also use the other transmitter and receiver module 110b for communication with elements included in the other network 14. It is to be noted that the wireless gateway station GW may be configured to include an addition transmitter and receiver module, not shown, having the same structure as the module 110a or 110b so that the one module 110a and the additional module are employed for the common channel and the subchannel, respectively, of the wireless multi-hop network 10 to which the module 200 belong, as done by the control flow shown in FIG. 6.

The number and type of transmitter and receiver modules may be different from those of the configuration in FIG. 2 depending on the environment or the like in which the gateway wireless station GW1 is provided, as will be described below. When the other network is a wired network and the gateway wireless station GW1 functions as a gateway device compatible with such a wired network, the other transmitter and receiver module 110b may be adapted for a wired network.

When the other network is a wireless multi-hop network to use any one of the plurality of channels for communication with the other network, it is necessary to provide a corresponding plurality of second transmitter and receiver modules 110b to the number of channels to be searched for, or alternatively a type of transmitter and receiver module that may rapidly switch the channels. The type of transmitter and receiver module that may rapidly switch the channels may also be used as the transmitter and receiver module 110a adapted for communication with other elements or wireless stations existing in the wireless multi-hop network 10 to which that wireless station 200 containing the module 110a belongs.

When the gateway wireless station GW1 includes one rapidly switchable type of transmitter and receiver module, or alternatively, more than one rapidly switchable type of transmitter and receiver modules when communicating in one wireless multi-hop network 10 while switching the channels for searching for the other network 14, the transmitter and receiver module used for the search has to be adapted to simultaneously handle the identifications (IDs) of the different wireless multi-hop networks in order to implement the gateway function.

Even when one or more normal transmitter and receiver modules are exclusively used for searching for the other wireless multi-hop network, one transmitter and receiver module has to handle the identification of one wireless multi-hop network other than the wireless multi-hop network to which the wireless station including that transmitter and receiver module belongs. In other words, the transmitter and receiver module, when equipped with the function of confirming a wireless multi-hop network ID, has to be able to confirm any IDs, not only the IDs of the wireless multi-hop network to which that wireless station belongs.

When the wireless station 200 that works as the gateway GW1 of the wireless multi-hop network 10 is not connected to any other network, it will search for such other network. In order to search for another network, which is a wireless multi-hop network in this example, the gateway wireless station GW1 uses, for searching, the transmitter and receiver module for communication with such other network as described above, for example.

FIG. 10 shows two wireless multi-hop networks 10 and 14 each of which is formed by the wireless stations 200 including the couple of transmitter and receiver modules 110a and 110b or more. Each wireless station 200 is allocated to the common channel and subchannel by the method according to the illustrative embodiment shown in and described with reference to FIGS. 5-9. The common channels of the first wireless network 10 are the links depicted with the solid arrows 125. The common channels of the second wireless network 14 are the links indicated by broken arrows 133.

The gateway wireless station GW2 in the second wireless multi-hop network 14 shown in FIG. 10 uses the transmitter and receiver module for searching stated above to sequentially select either of the four types of channels available for the gateway wireless station GW2 while transmitting search packets for searching for another neighboring wireless multi-hop network, such as the network 10.

The wireless stations 200, e.g. the stations #20, #28 and #30, in the first wireless multi-hop network 10 receive a search packet on the common channel of the first network 10, and then inform the management station ,for example, gateway wireless station GW1, to which the stations belong in the first network 10 of the search packet receipt. The management station GW1 selects and decides a wireless station, for example, the wireless station #30, for connection with the second wireless multi-hop network 14 that has transmitted that search packet.

The management station GW1 causes the wireless station #30 for connection to transmit a return packet on the common channel of the first wireless multi-hop network 10 to the gateway wireless station GW2 in the second wireless multi-hop network 14 that has transmitted the search packet. The return packet includes the wireless station information and path information or the like on the first wireless multi-hop network 10. Alternatively, the system 10 may be adapted to allow the wireless stations that have received the search packet to transmit the return packet to the gateway wireless station GW2 without informing the management station GW1. In the latter case, the gateway wireless station GW2 makes both the networks 10 and 14 connectable to each other, and thereafter the wireless stations that have received the search packet may inform the management station GW1 of the fact that both the networks 10 and 14 are in the connectable state thereof.

The return packet is received by the gateway wireless station GW2, which manages information such as wireless station information and path information on the second wireless multi-hop network 14 to which the gateway wireless station GW2 belongs, and which will further manage the wireless station information and path information on the first wireless multi-hop network 10 that has transmitted the return packet. The gateway wireless station GW2 may thus operate as a communication gateway between both the networks 10 and 14.

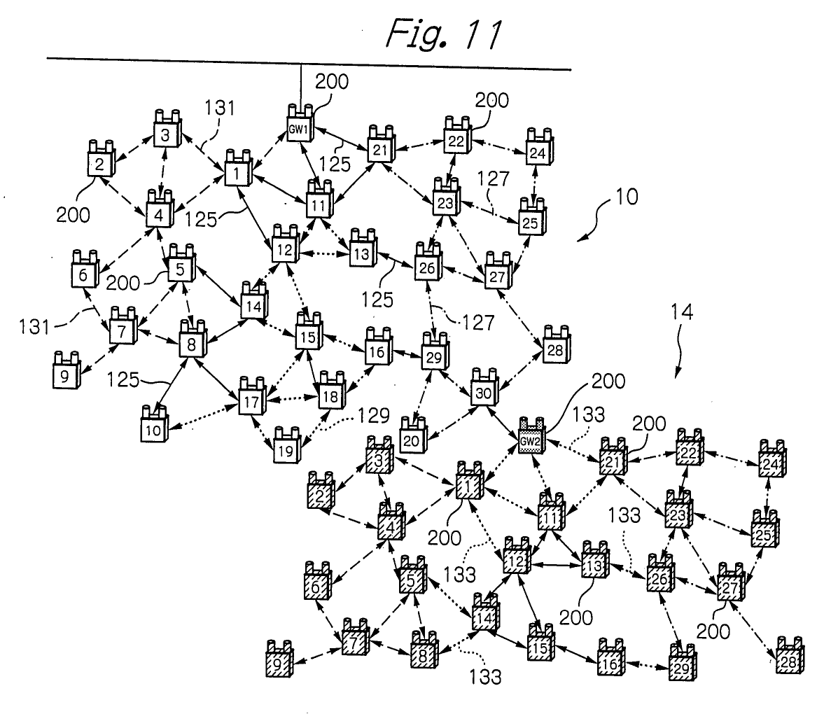

FIG. 11 illustrates the gateway wireless station GW2 operating, after having conducted the search operation, as a communication gateway between both the networks 10 and 14. In the state shown in FIG. 11, the gateway wireless station GW2 is in its state that it is connected to the first wireless multi-hop network 10, which has been made connectable, over the common channel of the gateway GW2, which has its transmitter and receiver module directed to the first wireless multi-hop network 10 set to the common channel.

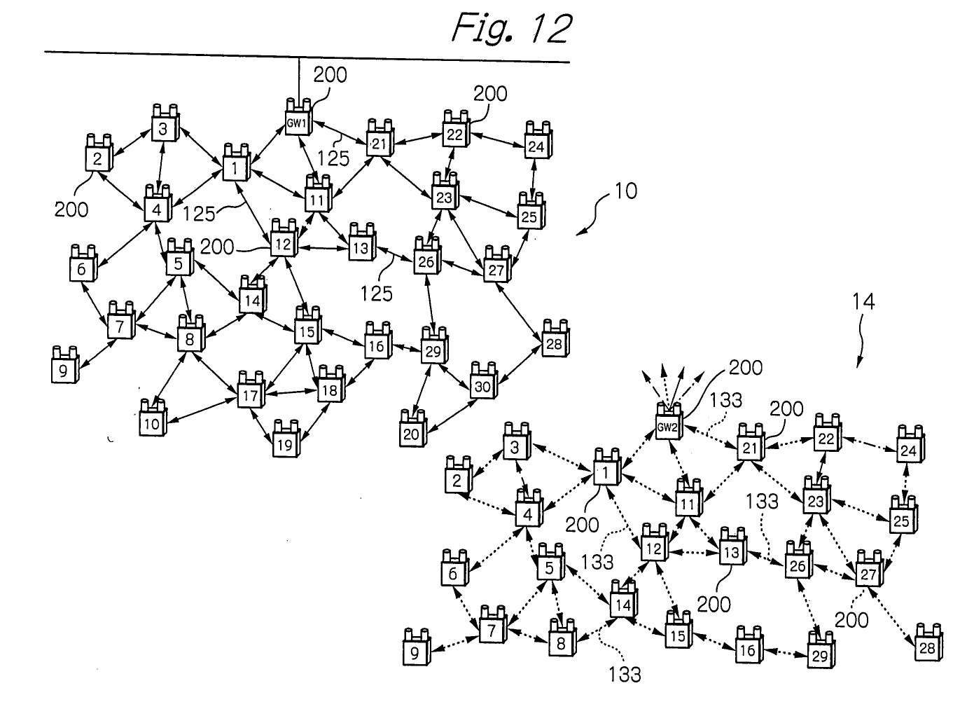

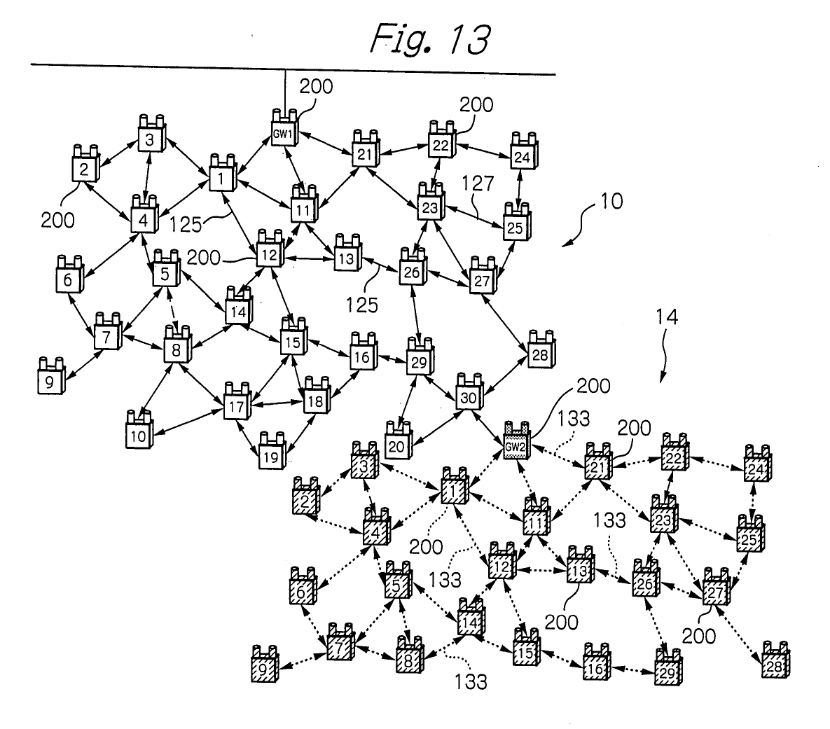

FIGS. 12 and 13 illustrate the state that both of the wireless multi-hop networks 10 and 14 are formed by the wireless stations 100, which have the single transmitter and receiver module 110, FIG. 1, and the gateway device GW2 conducts the searching and operates as a communication gateway between both the networks 10 and 14 as described above.

Although a description has been given of the gateway wireless station GW2 which, after the subchannel allocation is completed, for example, autonomously starts the search and makes the two networks 10 and 14 connectable, the gateway wireless station GW2 may be adapted to make both the networks 10 and 14 connectable after receiving a signal from the other network 10.

When the management station, e.g. the gateway wireless station GW1, of the first wireless multi-hop network 10 checks, for example, whether or not another wireless multi-hop network exists, it broadcasts to all wireless stations in the first wireless multi-hop network 10 packets that require the wireless stations to transmit a beacon indicating the check. Each wireless station then transmits the beacon.

The single transmitter and receiver module 110 or either of the transmitter and receiver modules 110a and 110b shown in FIG. 1 or 2 may function as circuitry for transmitting such a beacon. Alternatively, a separate beacon transmitter may be provided that is different from the transmitter and receiver module 110, 110a or 110b, FIG. 1 or 2. Further alternatively, the management station such as GW1, an external device or the like may be adapted for transmitting beacons with extensive electric power.

In addition to the situation in which a beacon is transmitted in case an irrelevant wireless multi-hop network possibly neighbors, in order to connect two wireless multi-hop networks having the same wireless network ID but not connected to each other, such a beacon may be transmitted from either one of the two wireless multi-hop networks.

The beacon may be a simple signal in the form of, e.g. a packet containing data of all “0” or all “1” that identifies one of the four channels. The beacon may also be a signal incorporating significant information such as the wireless network ID. The beacon may also be a simple signal having a specific frequency component.

As circuitry for receiving a beacon in the gateway wireless station GW2, use may be made of the single transmitter and receiver module 110 or either of the transmitter and receiver modules 110a and 110b, FIG. 1 or 2. Alternatively, a separate device for receiving a beacon may be provided that is different from the transmitter and receiver modules 110, 110a and 110b, FIG. 1 or 2.

The gateway wireless station GW2 in the second wireless multi-hop network 14, after having received the beacon, transmits and receives a predetermined packet to and from the first wireless multi-hop network 10 according to a predetermined procedure, and becomes connectable with the first wireless multi-hop network 10.

Regardless of the searching or being triggered with a beacon, two aspects may be applied, for example, in which the gateway wireless station GW2 makes the first and second wireless multi-hop networks 10 and 14 connectable to each other. Note that different aspects may be applied for different methods of starting up processing. For example, the first aspect may be applied for the searching, while the second aspect may be applied for being triggered with a beacon.

The first aspect corresponds to the first and second wireless multi-hop networks 10 and 14, when having the wireless network IDs thereof separate from each other. The gateway wireless station GW2 still operates as a gateway wireless station after the networks become connectable.

The first and second wireless multi-hop networks 10 and 14 may be adapted to maintain, when become connectable in the first aspect by the function of the gateway wireless station GW2, the common channels or the like in the respective networks. When the networks have the common channels thereof or the like different from each other as shown in FIG. 10, the common channels or the like may uniformly be set to either one of them.

With the latter alternative, the following processes, for example, may be performed. For example, when the wireless networks 10 and 14 are allocated to channels different from each other in such a way that the first wireless multi-hop network 10 has the common channel CH1, the first subchannel CH2, the second subchannel CH3 and the third subchannel CH4, while the second wireless multi-hop network 14 has the common channel CH3, the first subchannel CH4, the second subchannel CH1 and the third subchannel CH2, the gateway wireless station GW2 instructs the wireless stations in the second wireless multi-hop network 14 via broadcast, for example, to modify the channel allocation so as to be consistent with the allocation in the first wireless multi-hop network 10, in order to provide the same channel allocation in the first and second wireless multi-hop networks 10 and 14.

In the second aspect in which the gateway wireless station GW2 makes the first and second wireless multi-hop networks 10 and 14 connectable, the gateway wireless station GW2 has (the wireless stations 200 of) the second wireless multi-hop network 14 participate in the first wireless multi-hop network 10. In other words, the second wireless multi-hop network is incorporated into, or merged with, the first wireless multi-hop network 10, so that the gateway wireless station GW2, after incorporated, behaves as a normal wireless station.

The second aspect is applicable not only when the first and second wireless multi-hop networks 10 and 14 have the same wireless network ID from the beginning, but also when the first and second wireless multi-hop networks 10 and 14 initially have different wireless network IDs.

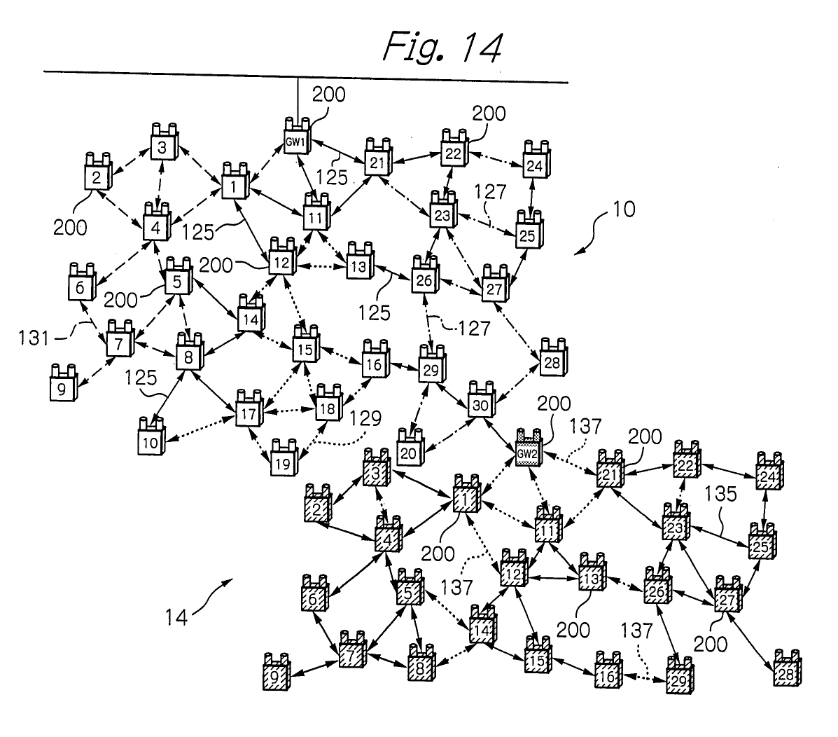

When the second wireless multi-hop network 14 to which the gateway wireless station GW2 belongs is incorporated into the first wireless multi-hop network 10, the second wireless multi-hop network 14 sets the common channel on the connection destination (the links with solid arrows 135 in FIG. 14 as described below) in the transmitter and receiver module different from that has been used on the common channel (the links with dotted arrows 137 in FIG. 14 as also described below) of the station GW2 in the second wireless multi-hop network 14. When the gateway wireless station GW2 is a switchable type of transmitter and receiver module, it may set the common channel in the second wireless multi-hop network 14 and the common channel of the connection destination at the same time.

The gateway wireless station GW2 transmits to the wireless stations 200 in the second wireless multi-hop network 14 on a broadcast or multi-hop packet for channel modification an instruction for setting as a subchannel the common channel previously used and for setting the common channel in the first wireless multi-hop network 10 to which the network 14 is newly connected as a new common channel. When the remaining subchannels are different between the two networks, the subchannels may not be modified, or alter natively an instruction maybe issued for selecting one of the subchannels to be used in common. After receiving such a broadcast packet for channel modification, the wireless stations 200, when acting as a wireless station requiring to relay a packet, in the second wireless multi-hop network 14 relay the packet. The wireless stations then set the new common channel and subchannel in the transmitter and receiver modules that have been used on the common channel and subchannel.

It is to be note that when the first and second wireless multi-hop networks 10 and 14 initially have the different wireless network IDs, the broadcast packet for channel modification may also incorporate the wireless network ID of the first wireless multi-hop network 10, and may cause the wireless stations 200 in the second wireless multi-hop network 14 to modify their wireless network IDs.

FIG. 14 illustrates how to modify the channels when the second wireless multi-hop network 14 is incorporated into the first wireless multi-hop network 10 so that both networks are coupled with each other. For example, when the second wireless multi-hop network 14 has its original common channel CH1 and the first wireless multi-hop network 10 to which the former will participate has its common channel CH2, the second wireless multi-hop network 14 will also have the channel CH2 as its common channel, so that the wireless stations that have used the channel CH2 as the subchannel thereof may modify the subchannel to the channel CH1.

Such a modification may maintain the grouping state in the second wireless multi-hop network 14. The wireless stations that have been allocated, before the first and second wireless multi-hop networks 10 and 14 are coupled, to the common channel and to, as the subchannel, the same channel as the common channel of the network 10 to which the network 14 participates are allowed to operate without modifying the channels allocated to the two transmitter and receiver modules even when the common channel and subchannel have been modified in nature.

In the alternative embodiment, the gateway wireless station reserves one of its transmitter and receiver modules for coupling the networks, or includes a transmitter and receiver module that may rapidly switch the channels, thereby advantageously being applicable to coupling a plurality of wireless multi-hop networks to each other.

When different wireless network IDs are managed after a plurality of wireless multi-hop networks are coupled with each other, the gateway wireless station may make the common channels both in the coupling source and destination operative at the same time, so that the wireless stations except the gateway wireless station in all the wireless multi-hop networks may continue to operate without modifying the channels.

For one wireless multi-hop network having the same wireless network ID configured after coupled, the gateway wireless station modifies the common channel and only one of the subchannels of the coupling destination, or the network participating, depending on the common channel of the coupling source, or the network to be participated. The wireless multi-hop network may thus be reconstructed without modifying the channels of the transmitter and receiver module that operates on the original common channel in the channel-modified wireless stations. Therefore, even when the wireless stations are in communication with each other, one of the transmitter and receiver modules is still reserved, thereby preventing the communication from being interrupted.

In the above, the various modifications have been described in connection with the illustrative embodiments. Further modifications will be described below.

In the process of the illustrative embodiment shown in FIG. 6, when there is one block, it is determined whether or not the process moves to the next hop and performs the grouping again, depending upon whether the number of hops from the gateway wireless station is half or more, or less than half, of the number of the longest hops. However, it may not be determined by using the number of hops, but by any other suitable methods. For example, it may be determined whether or not the process moves to the next hop and performs the grouping again by determining whether the number of the wireless stations up to the appropriate number of hops is half or more, or less than half, of the number of the wireless stations in the wireless multi-hop network. The reference value for determination is not limited to the half but may be the third, for example. For more allocatable channels, a reference value for determination may be 1/n, accordingly, where n is a natural number.

In the process of the illustrative embodiment shown in FIG. 6, when there are three or more wireless stations to be involved in relaying in one hop from the gateway wireless station, no GW subchannel is set. Alternatively, the gateway wireless station may also select and use any subchannel in the three blocks. In the latter case, in the wireless multi-hop network 10, a GW subchannel is also set to the gateway wireless station GW, and the situation of the network 10 corresponds to the situation shown in FIG. 9.

When a type of transmitter and receiver module that may rapidly switch channels is used as at least one of the transmitter and receiver modules in the gateway wireless station, that transmitter and receiver module may be adapted to be operative in switching the subchannels during transferring a packet from the gateway wireless station to the respective wireless stations to be involved in relaying in one hop. In the wireless multi-hop network 10, the gateway wireless station GW switches and sets the subchannels, and the situation corresponds to the situation shown in FIG. 9. In an application where the gateway wireless station GW includes many transmitter and receiver modules, the gateway wireless station GW may use the transmitter and receiver modules dedicatedly to transferring packets over the respective subchannels to the respective wireless stations to be involved in relaying in one hop.

The same GW subchannel may be unconditionally allocated to all wireless stations to be involved in relaying in one hop from the gateway wireless station. The use of the common channel of the gateway wireless station may thus be reduced, thereby avoiding the impending situation of the common channel as a wireless resource. With this modification, even in the case of three or more wireless stations to be involved in relaying in one hop from the gateway wireless station, blocks are transversely set in the vicinity of the gateway wireless station, and it then is determined whether or not blocks are required to be set in the vertical direction. This process may be the same as represented by steps S100 through S111 shown in the form of flowchart of FIG. 6, for example.

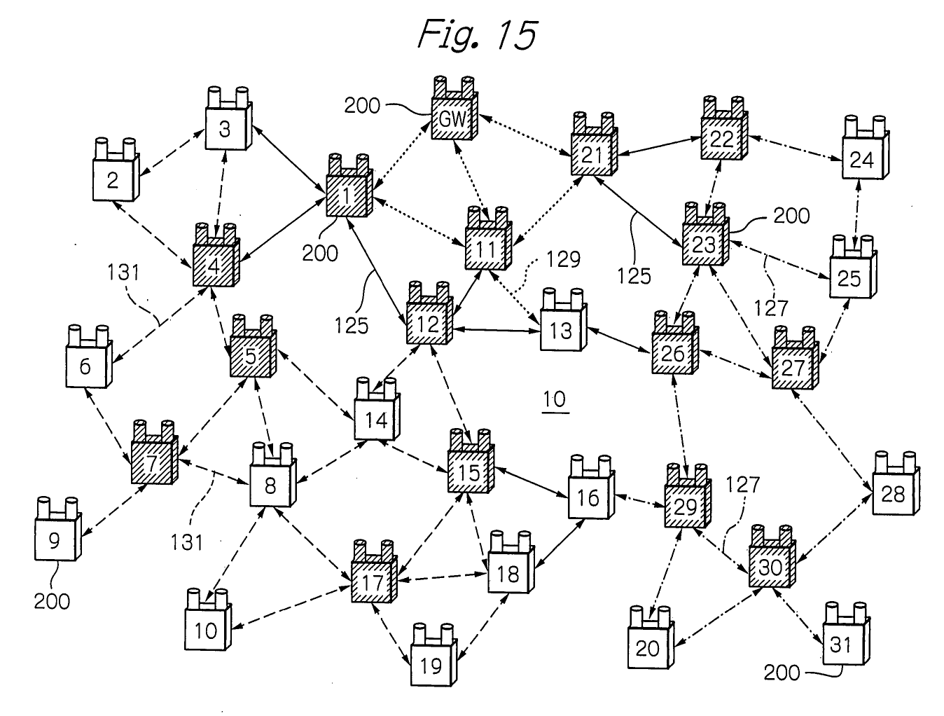

The flowchart shown in and described with reference to FIG. 6 is applied to the case of two or less wireless stations to be involved in relaying in one hop from the gateway wireless station. The flowchart shown in FIG. 6 is applicable to the case of any number of wireless stations to be involved in relaying in one hop from the gateway wireless station. FIG. 15 illustrates the situation in which the same process as shown in FIG. 6 has been performed, corresponding to FIG. 9.

The buffer wireless station is structured to switchably belong, by simply modifying its channel, to either of the two blocks. Therefore, when the buffer wireless station is operating on the channel in one of the blocks and the communication resource of that channel becomes impending or tight, the buffer wireless station may switch to the channel of the other block if the other block is not so tight. The above switching and determination may be performed by the management station. Alternatively, the buffer wireless station may automatically switch the channels by managing the frequency of communication failures or the like. In the latter case, the buffer wireless station may provide information on the subchannels in the group to which that buffer wireless station belongs and also information on a switchable subchannel.

Although the above illustrative embodiment shown in and described with reference to, e.g. FIG. 5, generates the broadcast tree 12 beginning at the gateway wireless station GW, the beginning of the broadcast tree may not be limited to the gateway wireless station but may be a wireless station other than the gateway wireless station, such as a wireless station on which the traffic concentrates, because the broadcast tree is formed for the purpose of allocating the wireless stations to a plurality of blocks or groups. Also in this case, the channel allocation itself may be performed by the gateway wireless station or other devices.

Although the above illustrative embodiment shown in and described with reference to, e.g. FIG. 3 is directed to the gateway wireless station, the gateway wireless station may be replaced merely by an initial data source or final destination wireless station. Specifically, the gateway wireless station may be a wireless station that does not have a connection function with other networks but is in connection with a processing unit provided in a data source or destination.

The type of transmitter and receiver module that may rapidly switch the channels is equivalent in function to a plurality of transmitter and receiver modules, as described above. It is intended that according to the present invention the term, a plurality of transmitter and receiver modules, defined in the appended claims also covers an application of a type of transmitter and receiver module that may rapidly switch channels.

The entire disclosure of Japanese patent application No. 2005-261208 filed on Sep. 8, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method of allocating channels in a wireless multi-hop network including a plurality of wireless stations, comprising the steps of:
allocating one of a plurality of channels available to the wireless multi-hop network as a common channel common to all of the plurality of the wireless stations;
generating a broadcast tree beginning from any one of the plurality of wireless stations based on link information including path information on all of links formed between two of the plurality of wireless stations communicable in one hop;
using information on a branch of the generated broadcast tree to group all of the plurality of wireless stations into blocks; and
allocating to each of the blocks as a subchannel one of the plurality of channels which is different from the common channel to thereby decide the subchannels for the plurality of wireless stations corresponding to the plurality of channels.

2. The method in accordance with claim 1, wherein the wireless station beginning of the generated broadcast tree is a gateway wireless station that is a communication port of the wireless multi-hop network.

3. The method in accordance with claim 1, wherein one of the plurality of wireless stations which is located at a leaf of the generated broadcast tree not requiring to relay and which is capable of receiving relays from the wireless stations in at least two of the blocks which are allocated to the subchannels different from each other is selected as a buffer wireless station which, depending on a situation of the subchannel used in the block to which the wireless station belongs, switches to a subchannel allocated to another of the blocks.

4. The method in accordance with claim 1, wherein the branches of the generated broadcast tree are more than the subchannels allocatable, said method further comprising the steps of:
calculating a number of wireless stations belonging to a new block which would be generated by merging adjacent ones of the generated blocks;
merging into one block the adjacent blocks which would form the new block including a minimum number of the wireless stations; and
repeating said step of merging until the number of the blocks equals the number of the allocatable subchannels to thereby allocate to the subchannels to the blocks.

5. The method in accordance with claim 1, wherein, when the branches of the generated broadcast tree are less than the allocatable subchannels, a value equal derived by dividing a number of longest hops by a natural number is used as a basis to group stems of the broadcast tree in a traverse direction to thereby allocate the subchannels to the blocks.

6. The method in accordance with claim 1, wherein one of the subchannels allocated to the wireless station in a first hop in the broadcast tree is selected as the subchannel for the beginning wireless station.

7. The method in accordance with claim 1, wherein
the wireless stations in a range having a number of hops smaller than a predetermined value in the broadcast tree are grouped into one block, and are unconditionally allocated to a same subchannel as the beginning wireless station, and
the wireless stations in hops of which a number is larger than the predetermined value are allocated to remaining subchannels allocatable.

8. The method in accordance with claim 1, wherein the beginning wireless station of the broadcast tree is connected to the wireless stations in a first hop by using the subchannel allocated to the wireless stations in the first hop.

9. The method in accordance with claim 2, wherein, when the gateway wireless station is not connected to any other wireless multi-hop network, the gateway wireless station searches for any other wireless multi-hop network, and manages wireless station information and path information on another wireless multi-hop network searched for, as well as sets in the gateway station the common channel of the other wireless multi-hop network searched for to operate as a communication gateway between both wireless multi-hop networks.

10. The method in accordance with claim 2, wherein the wireless multi-hop network to which the gateway wireless station belongs acts as a portion of another wireless multi-hop network, and the gateway wireless station has a function of connecting to the other wireless multi-hop network.

11. The method in accordance with claim 10, wherein said gateway wireless station modifies the common channel of the wireless multi-hop network to which the gateway wireless station belong to a common channel of the other wireless multi-hop network, modifies the subchannel to a new common channel, and modifies the previous common channel to a new subchannel.

12. A wireless communication system comprising a wireless station forming a wireless multi-hop network, wherein said wireless station is allocated to a common channel and a subchannel by allocating one of a plurality of channels available to the wireless multi-hop network as a common channel common to all wireless stations in the network;
generating a broadcast tree beginning from any one of the wireless stations based on link information including path information on all of links formed between two of the wireless stations communicable in one hop;
using information on a branch of the generated broadcast tree to group all of the wireless stations into blocks; and
allocating to each of the blocks as a subchannel one of the plurality of channels which is different from the common channel to thereby decide the subchannels for the wireless stations corresponding to the plurality of channels.
